(19) United States
(12) Patent Application Publication
(10) Pub. No.: US 2024/0419127 A1
(43) Pub. Date: Dec. 19, 2024

(54) LEVER DEVICE FOR A CLOCK MECHANISM

(71) Applicant: MANUFACTURE D'HORLOGERIE AUDEMARS PIGUET SA, Le Brassus (CH)

(72) Inventor: Olivier GUMY, La Praz (CH)

(73) Assignee: MANUFACTURE D'HORLOGERIE AUDEMARS PIGUET SA, Le Brassus (CH)

(21) Appl. No.: 18/722,405

(22) PCT Filed: Dec. 15, 2022
(86) PCT No.: PCT/IB2022/062283

§ 371 Date: Jun. 20, 2024

(30) Foreign Application Priority Data
Dec. 21, 2021 (EP) 21216291.1

(51) Int. Cl. G04F 7/08

(52) U.S. Cl. CPC G04F 7/0828; G04F 7/0847

(57) ABSTRACT

The present invention relates to a lever device (10) of a watch mechanism, comprising a column wheel (16) and a main lever (20) mounted so as to pivot, about a first pivot axis (24), alternately between two stable positions. The main lever (20) comprises an anchor provided with two beaks (21a, 21b) which, in each of the two stable positions, are alternately located, one of them between two columns (17) and the other in contact with a peripheral flank of another column (17). The main lever (20) further comprises a distal part (26, 29) for controlling the watch mechanism. The anchor and the distal part (26, 29) of the lever are arranged to pivot about the first pivot axis (24). The invention also relates to a watch movement comprising a chronograph and the lever device arranged to bring the chronograph from a disengaged configuration to an engaged configuration and vice versa.

### TECHNICAL DOMAIN

The present invention relates to a lever device for a watch mechanism. The lever device can be used in particular to actuate a chronograph clutch.

### PRIOR ART

Conventional chronographs generally comprise a column wheel which constitutes the control centre of the chronograph mechanism for starting, stopping and resetting the measuring functions. The column wheel is adapted to control the movement of levers and other rockers which are held against the column wheel by springs to actuate a clutch of either the vertical or horizontal/lateral type.

In a chronograph of the vertical gear type, a clutch shoe is arranged to occupy a disengaged position, corresponding to the stop position of the chronograph, and an engaged position, corresponding to the running position of the chronograph, where the clutch shoe is engaged with a mobile of the seconds. The latter meshes directly or indirectly with a gear train of the watch movement in order to transmit the movement to the chronograph axis which carries the chronograph seconds hand.

EP2015145 discloses a chronograph comprising a vertical type clutch. The chronograph comprises a clamp consisting of two branches forming an integral part of a main lever and a secondary lever. The clamp is designed to axially displace the clutch shoe of the clutch mobile so that the latter passes from an engaged configuration, in which the chronograph mobile is driven by the seconds wheel via the clutch mobile, to a disengaged configuration, in which the clutch shoe is disengaged from the clutch mobile. The main lever controls the secondary lever and cooperates with a column wheel via a beak.

Conventionally, the column wheel is controlled by a stop/start push-button of the chronograph. Each press of the push-button rotates the column wheel by one step, which closes or opens the clamp depending on the position of the beak of the main lever relative to the columns. In every other angular position of the column wheel, the beak rests on an external flank of a column of the wheel against the action of a return spring of the clamp, which keeps the clamp in its closed position. In angular positions of the column wheel where the beak is located between two columns, the action of the return spring keeps the clamp in its open position.

The force exerted by the clamp return spring has several disadvantages. The torque induced by the pressure of the beak on the column wheel is significant, which can cause non-negligible wear to the mechanism in the long term. In addition, in order to overcome the constraints exerted by the return spring, relatively high pressure must be exerted on the push-button to start and stop the chronograph.

EP0490285 relates to a control device for a chronograph and which comprises a clamp, a mobile disposed between the free ends of the two branches of the clamp, two fixed reaction members against which a connecting portion between the two branches of the clamp is pressed, and deformation means generating a force acting against the reaction members on the connecting portion in order to deform the latter.

This control device has a number of disadvantages, particularly due to its complexity and its operating principle, which may have an impact on its long-term reliability. This device comprises in fact a two-stage mobile, a thrust and positioning member arranged to cooperate with the mobile, a control lever to rotate the mobile in order to actuate the thrust and positioning member and a clamp arranged to cooperate with a chronograph mobile. This clamp comprises an elastic blade designed to deform under the action of the thrust member to open the clamp in order to start the chronograph. The elastic properties of the blade may deteriorate over time, which may modify the positioning of the arms of the clamp.

An object of the present invention is therefore to propose a lever device for a watch mechanism, in particular a chronograph, devoid of the aforementioned disadvantages.

More particularly, an object of the present invention is to provide a lever device subject to reduced forces when the device is actuated in order to limit premature wear of the device parts.

Another object of the present invention is to provide a lever device locked in either of two states or configurations of the start/stop or on/off type in order to minimise the impact of shocks on the parts of the device.

An additional object of the present invention is to provide a lever device whose actuation requires less pressure on the push-button in order to improve comfort of use.

A further object of the present invention is to provide a simplified lever device with a limited number of parts in order to reduce production costs and increase the reliability of the device.

### BRIEF SUMMARY OF THE INVENTION

According to the invention, these objects are achieved in particular by a lever device of a watch mechanism, comprising a column wheel and a main lever mounted so as to pivot, about a first pivot axis, alternately between two stable positions. The main lever comprises an anchor provided with two beaks which, in each of the two stable positions, are alternately located, one between two columns and the other in contact with a peripheral flank of another column. The main lever also has a distal part for controlling the watch mechanism. The anchor and the distal part of the lever are arranged to pivot about the first pivot axis.

In an embodiment, the main lever is rigid.

In an embodiment, the main lever is in one-piece.

In an embodiment, the first and second beaks of the anchor are arranged on either side of the column wheel. These beaks form an angle between them, relative to the axis of rotation of the column wheel, comprised between 90° and 270°, preferably between 120° and 180°, ideally between 140° and 160°.

In an embodiment, the main lever comprises an edge extending between the first and second beaks substantially along an arc of a circle defined by the peripheral flanks of the columns of the column wheel.

In an embodiment, a gap exists between the edge and the arc of a circle defined by the peripheral flanks of the said columns so that only the first and second beaks are in contact with the columns of the column wheel when the main lever pivots into one or the other of the two stable positions.

In an embodiment, the main lever is in a locked configuration in either of the two stable positions.

In an embodiment, the lever device further comprises a secondary lever arranged to cooperate with the main lever. The secondary lever comprises a distal part to form a clamp with the distal part of the main lever. The respective distal parts of the main lever and the secondary lever move towards each other when the main lever is brought into one of the two stable positions. The distal parts move away from each other when the main lever is brought into the other of the two stable positions.

Another aspect of the invention relates to a watch movement comprising the above-mentioned lever device.

In an embodiment, the watch mechanism is a chronograph comprising a push-button command arranged to rotate the column wheel of the lever device. The column wheel is preferably rotated by means of a click cooperating with a ratchet of this column wheel. This rotation enables the main lever to be tilted into one or the other of two stable positions in order to bring the distal part into one or the other of a first and a second location corresponding respectively to an engaged and disengaged configuration of the chronograph.

In an embodiment, the chronograph is a chronograph with a lateral clutch comprising a chronograph wheel and a clutch wheel pivotally mounted on the distal part of the main lever so as to be engaged with a seconds wheel of the watch movement. The clutch wheel is arranged to be distant from the chronograph wheel when the main lever is in one of two stable positions in order to maintain the chronograph in a disengaged configuration. The clutch wheel is further arranged to engage with the chronograph wheel when the main lever is brought into the other of the two stable positions in order to bring the chronograph into an engaged configuration.

In an embodiment, the chronograph comprises a chronograph mobile with a vertical clutch comprising a mobile of the seconds engaged with a gear train of the watch movement, a chronograph axis on which the mobile of the seconds is mounted so as to pivot freely, a clutch shoe mounted on the chronograph axis, and a clutch spring cooperating with the clutch shoe. The respective distal parts of the main lever and of the secondary lever of the lever device according to the embodiment mentioned above move towards each other when the main lever is brought into one of the two stable positions so as to cooperate with the clutch shoe in order to keep the latter at a distance from the mobile of the seconds so that the chronograph mobile is in a disengaged configuration. The distal parts move away from each other when the main lever is brought into the other of the two stable positions in order to bring the chronograph mobile into an engaged configuration in which the clutch shoe is held against the mobile of the seconds, under the action of the clutch spring, in order to be driven by the mobile of the seconds by friction.

In an embodiment, the clutch shoe is in the form of a cup comprising a lower surface intended to come into contact with the mobile of the seconds in the engaged configuration of the chronograph mobile. The clutch spring is in contact with a shoulder or collar of the chronograph axis in order to press the cup against the mobile of the seconds.

In an embodiment, an upper part of the cup comprises an annular edge. The respective distal parts of the main lever and of the secondary lever are arranged to be positioned under the annular edge in order to axially displace the clutch shoe so that the latter is disengaged from the mobile of the seconds when the chronograph mobile is brought into the disengaged configuration.

Another aspect of the invention relates to a timepiece, in particular a wristwatch, comprising the lever device.

### BRIEF DESCRIPTION OF THE FIGURES

Examples of embodiments of the invention are shown in the description illustrated by the appended figures in which:

FIG. 1 shows a perspective view of the lever device arranged to control the start and stop of a chronograph mobile of the vertical clutch type of a chronograph according to a preferred embodiment of the invention;

FIG. 2 shows a top view of the lever device and of the chronograph mobile of FIG. 1;

FIG. 3 shows a top view of the chronograph mobile of FIG. 2 with the clamp formed by the distal parts of the main and secondary levers in engagement with the clutch shoe of the chronograph mobile;

FIG. 4 shows a cross-sectional view of FIG. 3 along A-A;

FIG. 5 shows a view similar to FIG. 3 when the chronograph is running;

FIG. 6 shows a cross-sectional view of FIG. 5 along A-A;

FIGS. 7a-7d show different sequences of movements of the lever device of FIG. 1 when the chronograph moves from a disengaged configuration to an engaged configuration and vice versa;

FIG. 8a shows a top view of the lever device, according to another embodiment, arranged to control the start and stop of a chronograph with a lateral clutch, when the latter is in a disengaged configuration, and

FIG. 8b shows a view similar to FIG. 8a when the chronograph is in an engaged configuration.

### EXAMPLES OF EMBODIMENT OF THE INVENTION

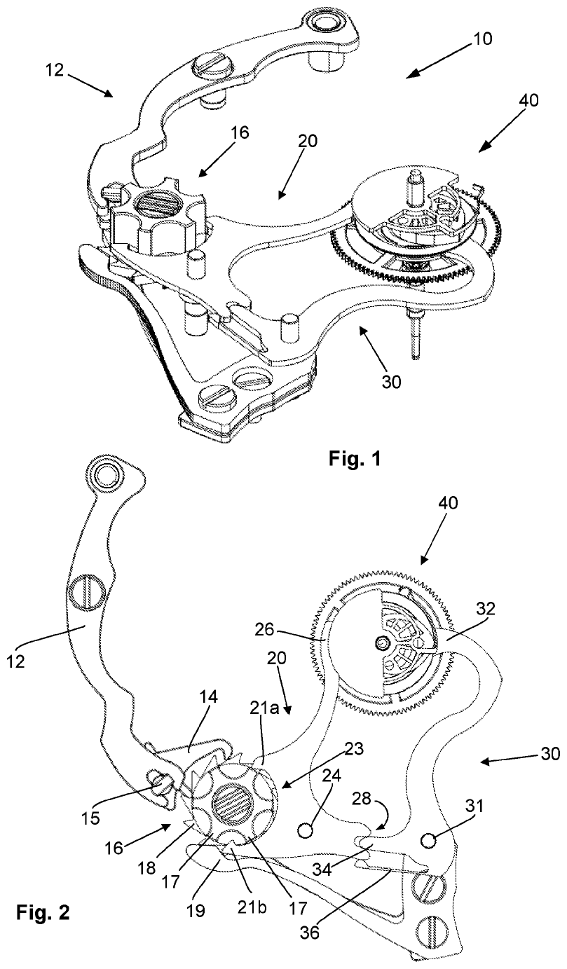

According to a preferred embodiment illustrated in particular in FIGS. 1 and 2, the lever device 10 is used to control the start and stop of a chronograph comprising a chronograph mobile with vertical clutch 40. To this end, the lever device 10 comprises a push-button command 12 that can be actuated by a push-button (not shown) located, for example, at 2 o'clock.

Conventionally, the push-button command 12 is arranged to rotate a column wheel 16 by means of a click 14 cooperating with the ratchet 18 of the column wheel, whose angular position at rest is maintained by a blade-spring 19. The click 14 is typically mounted so as to pivot on an axis by means of a bayonet system 15 providing the mechanical connection between the push-button command 12 and the click 14.

In an embodiment, the lever device 10 further comprises a main lever 20 mounted so as to pivot freely on a first pivot axis 24 and a secondary lever 30 mounted so as to pivot freely on a second pivot axis 31. Each of the levers 20, 30 comprises a distal part 26, 32 arranged on either side of the chronograph mobile 40 so as to form a clamp. Preferably, the main and secondary levers are each in one piece and rigid. The main lever 20 cooperates with the secondary lever 30 in order to move the distal parts 26, 32 against each other or in an opposite direction in order to fulfil the function of a clamp capable of bringing the chronograph mobile 40 from an engaged configuration to a disengaged configuration and vice versa according to the detailed description which will be given subsequently.

In order to induce the to-and-fro movements at the distal parts 26, 32 of the clamp, the main lever 20 comprises a part resembling an anchor provided with a first and a second beak 21a, 21b arranged to cooperate with the columns 17 of the column wheel 16, in the manner of an escapement anchor. The anchor and the distal part 26 of the main lever 20 are arranged on either side of the first pivot axis 24. This enables the main lever 20 to be brought from a first locked angular position, in which the distal parts 26, 32 hold the chronograph mobile 40 in the disengaged configuration, to a second locked angular position, so as to disengage the distal parts 26, 32 from the chronograph mobile 40 so that the latter passes from the disengaged configuration to the engaged configuration.

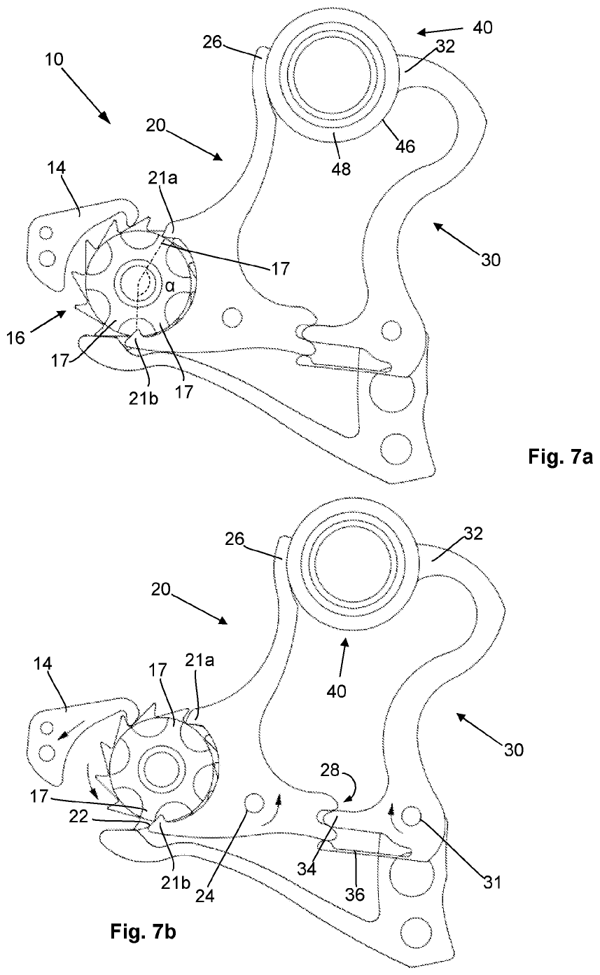

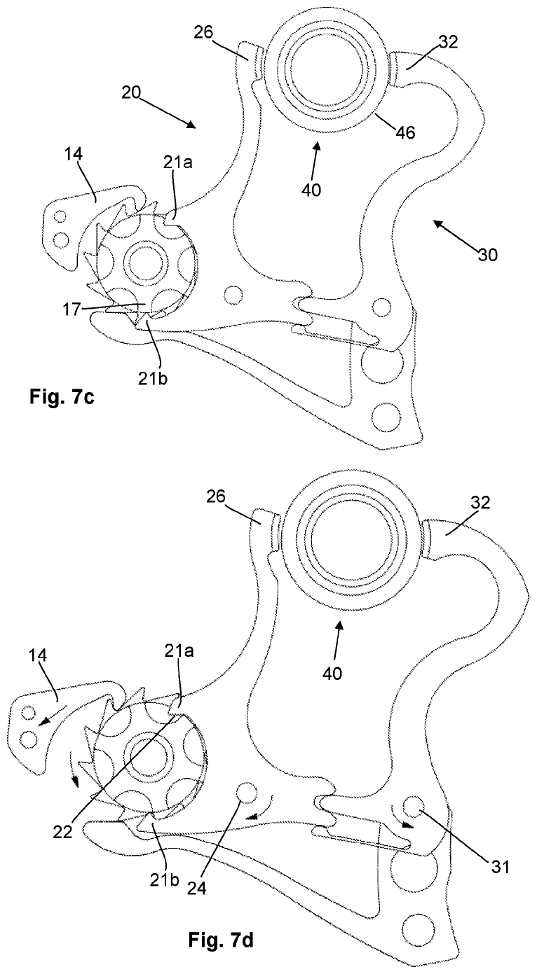

To this end, the first and second beaks 21a, 21b are located at the ends of an edge 23 of the main lever in the form of an arc of a circle extending substantially along part of a circle defined by the peripheral flanks of the columns 17 so that the two beaks are arranged on either side of the column wheel 16. The two beaks 21a, 21b form an angle α between them (FIG. 7a), relative to the axis of rotation of the column wheel, comprised between 90° and 270°, preferably between 120° and 180°, ideally between 140° and 160°.

A gap is provided between the edge 23 and the arc of a circle defined by the external flanks of said columns 17 so that only the first and second beaks 21a, 21b are in contact with the columns 17 of the column wheel when the main lever 20 pivots into one or the other of the first and second locked angular positions.

The lever device thus makes it possible, advantageously, to minimise the impact of shocks on the parts of the device since the main lever ensures a stable position in either of the two angular positions.

Each beak 21a, 21b of the main lever 20 has an impulse plane 22 (FIGS. 7b and 7d) intended to cooperate with the columns 17 of the column wheel, according to the description of the sequence of movements illustrated by FIGS. 7a to 7d detailed below, in order to actuate the main lever 20 into one or the other of the first and second positions.

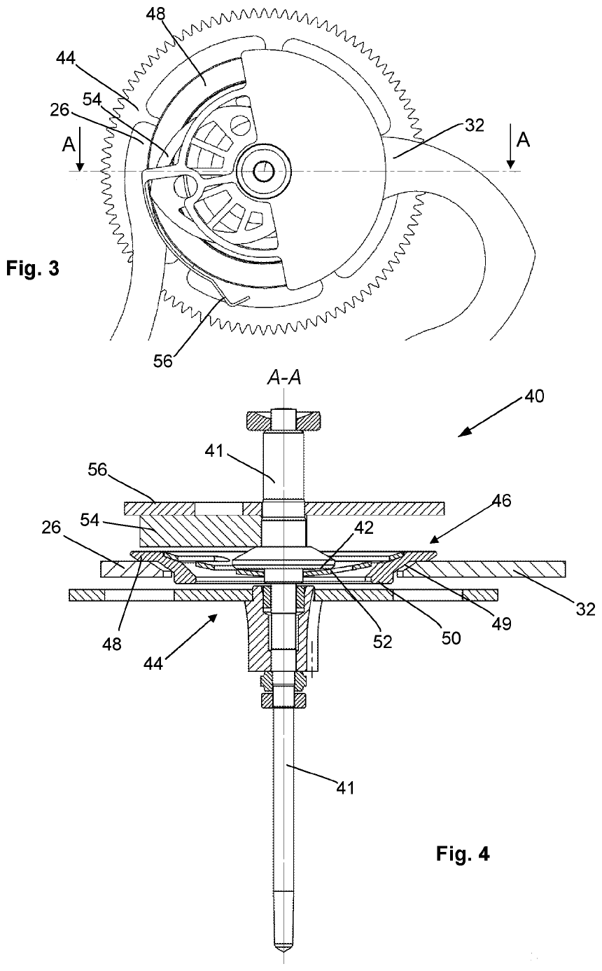

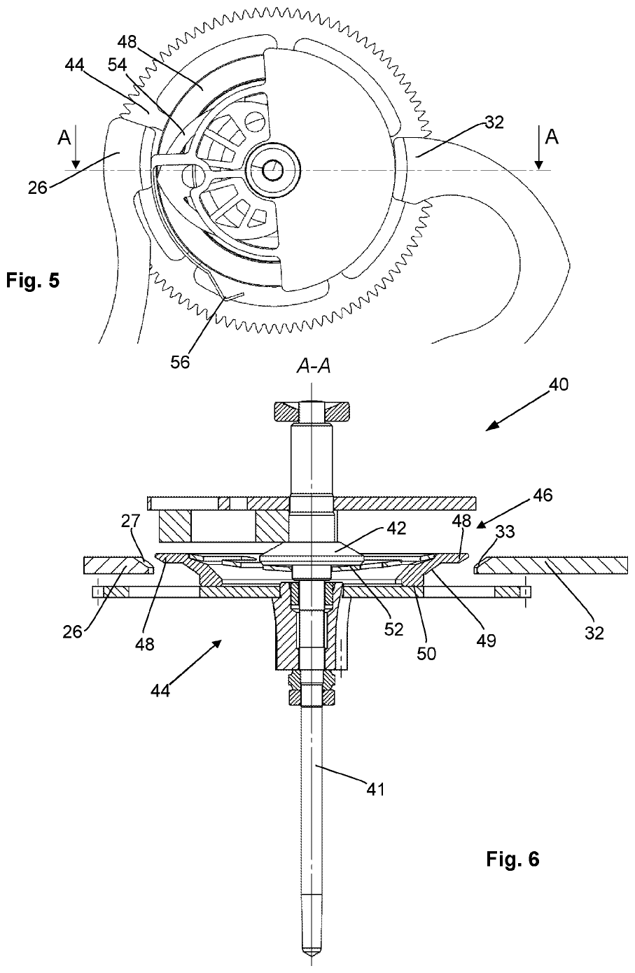

Referring to FIGS. 3 and 4, the chronograph mobile 40 comprises a mobile of the seconds 44 in direct or indirect engagement with the gear train (not shown) of the watch movement, a chronograph axis 41 on which the mobile of the seconds 44 is mounted so as to pivot freely, a clutch shoe 46 mounted on the chronograph axis 41 and a clutch spring 52 arranged to cooperate with the clutch shoe 46. The latter is preferably in the form of a cup.

The cup comprises a lower surface 50 intended to come into contact with the mobile of the seconds 44, an inclined flank 49 extending around the outer circumference of the cup 46 and an annular edge 48 extending radially from an upper part of the inclined flank 49 in a direction perpendicular to the chronograph axis 41. The cup 46 further comprises the clutch spring 52 bearing against a shoulder or a collar 42 formed on the chronograph axis 41. The clutch spring 52 may be secured or free to rotate on the chronograph axis 41.

The chronograph mobile 40 shown in FIG. 4 is in a disengaged configuration in which the ends of the respective distal parts 26, 32 of the main lever 20 and of the secondary lever 30 are in contact with the annular edge 48 of the clutch shoe 46 so as to keep the latter at a distance from the mobile of the seconds 44. In this configuration, the chronograph axis 41 is disconnected from the seconds wheel 44. The chronograph is therefore not running.

When the lever device 10 is actuated and the chronograph mobile 40 is in a disengaged configuration, the respective distal parts 26, 32 of the main lever 20 and of the secondary lever 30 move away from each other to reach the position illustrated in FIG. 6. The clutch shoe 46 is no longer supported by the distal parts 26, 32 and is pressed against the mobile of the seconds 44 by the clutch spring 52. The chronograph mobile 40 is thus in an engaged configuration in which the clutch shoe 46 is driven by the second mobile 44 by friction in order to rotate the chronograph axis 41. The chronograph is therefore running as soon as the distal parts 26, 32 are disengaged from the annular edge 48 of the clutch shoe 46.

When the lever device 10 is actuated again when the chronograph mobile 40 is in an engaged configuration, the ends of the distal parts 26, 32 exert a constraint on the side of the annular edge 48 of the clutch shoe 46, which causes an axial displacement of the latter so as to disengage it from the mobile of the seconds 44 to bring the chronograph mobile 40 into a disengaged configuration. The side of the annular edge 48 and/or the ends of the distal parts 26, 32 are bevelled 27 and 33, to allow axial movement of the clutch shoe 46.

According to FIGS. 4 and 6, the chronograph mobile 40 further comprises a cam 54, for resetting to zero the chronograph, secured to the chronograph axis 41. This cam 54 is arranged to be actuated by a lever (not shown) in order to reset the chronograph to zero. This lever can be actuated by a pusher located, for example, at 4 o'clock. A finger 56, preferably having elastic properties, is also secured to the chronograph axis 41 in order to rotate a minute wheel of the chronograph through a defined angle depending on the display of the number of minutes.

The different sequences of movement of the lever device 10 will now be described in relation to FIGS. 7a to 7d.

According to FIG. 7a, the lever device 10 holds the chronograph mobile 40 in a disengaged configuration. In this configuration, the tip of the first beak 21a of the anchor of the main lever 20 rests against the peripheral flank of a column 17 of the column wheel 16. The tip of the second beak 21b of the anchor of the main lever is located between two other columns 17. This guarantees an angular position of the main lever 20 and of the secondary lever 30 in which their distal parts 26, 32 hold the clutch shoe 46 of the chronograph mobile 40 at a distance from the mobile of the seconds 44 (FIG. 4). The chronograph is therefore stopped.

According to FIG. 7b, when the push-button command is actuated, the click 14 rotates the column wheel in a conventional manner. The tip of the first beak 21a is disengaged from the peripheral flank of the column on which it was resting while an impulse plane 22 of the second beak 21b comes into contact with another column 17 in order to pivot the main lever 20 counter-clockwise about its pivot axis 24 until the tip of the second beak 21b is resting on the peripheral flank of the column and the tip of the first beak 21a is between two other columns as illustrated in FIG. 7c.

According to FIG. 7b, the pivotal movement of the main lever 20 causes, via a mechanical connection, the secondary lever 30 to pivot clockwise about its pivot axis 31. In order to pivot the secondary lever 30, the main lever 20 comprises a main coupling part 28 coupled to a secondary coupling part 34 of the secondary lever 30. The latter may, for example, comprise a finger, one end of which is arranged in a cut-out on the main or secondary lever. The main lever 20 and/or the secondary lever 30 may also comprise a blade-spring 36 in order to exert a constraint on the mechanical connection, thus ensuring permanent contact between the two levers.

The pivotal movement of the main lever 20 in a direction opposite to the pivotal movement of the secondary lever 30 moves the respective distal parts 26, 32 in an opposite direction so as to release the clutch shoe 46, as described previously, so that it comes into contact with the mobile of the seconds 44 (FIG. 6) in order to start the chronograph.

When the push-button command is actuated again when the chronograph mobile 40 is in an engaged configuration, as shown in FIG. 7d, the click 14 again rotates the column wheel, as a result of which the tip of the second beak 21b is disengaged from the peripheral flank of the column on which it was bearing in the engaged configuration of the chronograph mobile 40, while an impulse plane 22 of the first beak 21a comes into contact with a column 17 in order to pivot the main lever 20 in a clockwise direction about its pivot axis 24 until the tip of the first beak 21a comes to bear on the peripheral flank of another column and the tip of the second beak 21b comes between two other columns in order to return to the disengaged configuration of the chronograph mobile 40 illustrated in FIG. 7a.

The main lever 20 is therefore always in contact with the peripheral flank of a column 17 of the column wheel 16, which makes it possible to dispense with a return spring which is necessary, according to chronograph levers in the state of the art, to enable the beak of the lever to cooperate with the columns of the column wheel.

This has a number of advantages, in particular less wear and tear on parts due to the reduction in the torque required to actuate the column wheel, mechanical locking of the start-stop functions, or also less pressure on the push-button in order to improve comfort of use.

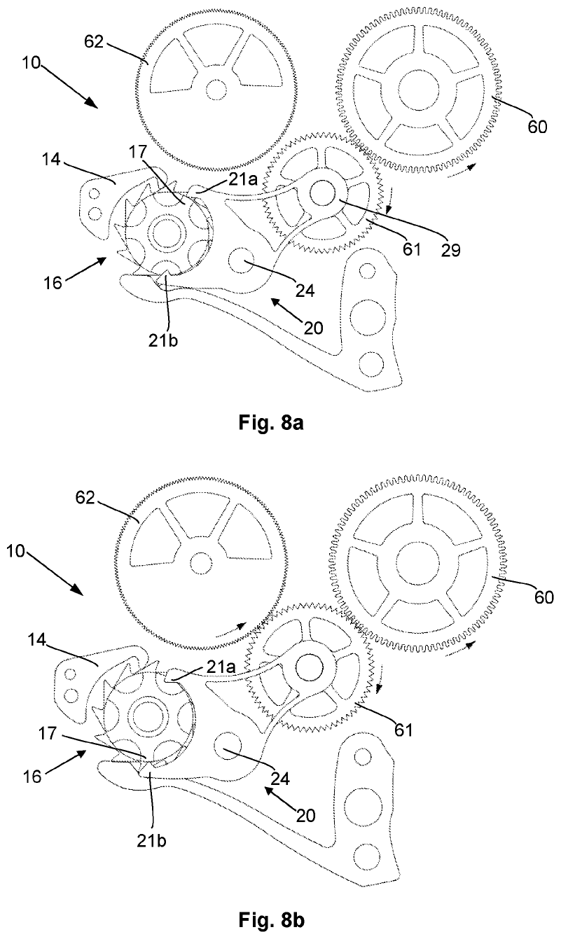

According to another embodiment illustrated in FIGS. 8a and 8b, the lever device 10 is adapted to command the start and stop of a chronograph with a lateral clutch.

To this end, a clutch wheel 61 is pivotally mounted on a distal part 29 of the main lever 20. The latter comprises, like the main lever in the first embodiment just described, an anchor provided with a first and a second beak 21a, 21b arranged to cooperate with the columns 17 of the column wheel 16 to cause the main lever 20 to pivot about its pivot axis 24 as described with reference to FIGS. 7a to 7d.

In the disengaged position illustrated in FIG. 8a, the clutch wheel 61, in mesh with the seconds wheel 60 of the watch movement, is at a distance from the chronograph wheel 62. When the push-button command (not illustrated) is actuated, the click 14 rotates the column wheel 16 to pivot the main lever 20 about its pivot axis 24 so that the clutch wheel 61 engages with the chronograph wheel 62 as shown in FIG. 8b.

It is preferable to provide a flexible main lever 20 and/or a clutch wheel 61 having elastic teeth in order to avoid or at least minimise premature wear caused by repeated impacts of the clutch wheel 61 against the chronograph wheel 62.

In another embodiment, the lever device 10 could comprise a column wheel 16 and at least one second main lever identical or similar to the first main lever 20. In this way, each of the main lever could be used to command the start and stop of a separate mechanism such as a timepiece complication. Alternatively, and for the same purpose, the lever device 10 could comprise a column wheel 16 and at least a second pair of main lever 20 and secondary lever 30. Each of the pairs of main and secondary levers could then control the start and stop of a separate mechanism such as the one mentioned above.

The lever device according to the invention is not limited to commanding the start and stop of a chronograph mechanism. It can be adapted to any type of watch mechanism provided with two states or configurations of the start/stop or on/off type, in order to bring it into one or other of these configurations.

Such a mechanism may, for example, be a display mechanism enabling a first and a second element of different visual appearance to be displayed successively, through a window for example, as the lever device is actuated. The lever device according to the invention can also be used to release a tensioned gear, to correct a mechanism or to select functions.

In addition, the lever device can be adapted for a continuous drive in order to display, for example, a day/night indication. In this case, the lever device is devoid of a push-button command, a click and a ratchet, the columns being secured to a wheel in mesh with the gear train of the watch movement.

### REFERENCE LIST

Lever device 10
   Push-button command 12
   Click 14
   Bayonet system 15
   Column wheel 16
      Columns 17
      Ratchet 18
   Blade-spring 19
   Main lever 20
      First and second beaks 21a, 21b
         Impulsion plan 22
      Edge 23
      Pivot axis 24
      Distal part 26, 29
         Inclined flank 27
      Main coupling part 28
   Secondary lever 30
      Pivot axis 31
      Distal part 32
         Inclined flank 33
      Secondary coupling part 34
      Blade-spring 36
Chronograph mobile 40
   Chronograph axis 41
      Collar 42
   Mobile of the seconds 44
   Clutch shoe 46
      Cup 47
         Annular edge 48
         Flanc conique 49
         Lower surface 50
         Clutch spring 52
   Cam 54
   Finger élastique 56
Seconds wheel 60
Clutch wheel 61
Chronograp wheel 62

1-15. (canceled)

16. Lever device for a watch mechanism, comprising a column wheel and a main lever mounted so as to pivot, about a first pivot axis, alternately between two stable positions, the main lever comprising an anchor provided with two beaks which, in each of the two stable positions, are alternately located, one of them between two columns and the other in contact with a peripheral flank of another column, the main lever further comprising a distal part for controlling the watch mechanism, wherein the distal part and the anchor of the main lever are arranged to pivot about the first pivot axis.

17. Lever device of claim 16, wherein the main lever is rigid.

18. Lever device of claim 16, wherein the main lever is in one-piece.

19. Lever device of claim 16, wherein the first and second beaks of the anchor are arranged on either side of the column wheel and form an angle between them, relative to the axis of rotation of the column wheel, comprised between 90° and 270°, preferably between 120° and 180°, ideally between 140° and 160°.

20. Lever device of claim 16, wherein the main lever comprises an edge extending between the first and second beaks substantially along an arc of a circle defined by the peripheral flanks of the columns of the column wheel.

21. Lever device of claim 20, wherein a gap exists between said edge and the arc of a circle defined by the peripheral flanks of said columns so that only the first and second beaks are in contact with the columns of the column wheel when the main lever pivots into one or the other of the two stable positions.

22. Lever device of claim 16, wherein said main lever is in a locked configuration in either of the two stable positions.

23. Lever device of claim 16, further comprising a secondary lever arranged to cooperate with the main lever, the secondary lever comprising a distal part in order to form a clamp with the distal part of the main lever, the respective distal parts of the main lever and of the secondary lever moving towards each other when the main lever is brought into one of the two stable positions, said distal parts moving away from each other when the main lever is brought into the other of the two stable positions.

24. Watch movement comprising a watch mechanism including the lever device of claim 1.

25. Watch movement of claim 24, wherein the watch mechanism is a chronograph comprising a push-button command arranged to rotate the column wheel of the lever device, preferably by means of a click cooperating with a ratchet of the column wheel, in order to pivot the main lever into one or the other of the two stable positions in order to bring the distal part of the main lever into one or the other of a first and a second location corresponding respectively to an engaged and disengaged configuration of the chronograph.

26. Watch movement of claim 25, wherein the chronograph is a lateral clutch chronograph comprising a chronograph wheel and a clutch wheel pivotally mounted on the distal part of the main lever so as to be in mesh with a seconds wheel of the watch movement, the clutch wheel being arranged to be distant from the chronograph wheel when the main lever is in one of the two stable positions in order to maintain the chronograph in a disengaged configuration, the clutch wheel being further arranged to engage with the chronograph wheel when the main lever is brought into the other of the two stable positions in order to bring the chronograph into an engaged configuration.

27. Watch movement of claim 25 and comprising the lever device for a watch mechanism, comprising a column wheel and a main lever mounted so as to pivot, about a first pivot axis, alternately between two stable positions, the main lever comprising an anchor provided with two beaks which, in each of the two stable positions, are alternately located, one of them between two columns and the other in contact with a peripheral flank of another column, the main lever further comprising a distal part for controlling the watch mechanism, wherein the distal part and the anchor of the main lever are arranged to pivot about the first pivot axis, wherein the chronograph comprises a chronograph mobile with vertical clutch comprising a mobile of the seconds in mesh with a gear train of the watch movement, a chronograph axis on which the mobile of the seconds is mounted so as to pivot freely, a clutch shoe mounted on the chronograph axis, and a clutch spring cooperating with the clutch shoe, the respective distal parts of the main lever and of the secondary lever of the lever device moving towards each other when the main lever is brought into one of the two stable positions so as to cooperate with the clutch shoe in order to keep the latter at a distance from the mobile of the seconds so that the chronograph hand is in a disengaged configuration, said distal parts moving away from each other when the main lever is brought into the other of the two stable positions in order to bring the chronograph mobile into an engaged configuration in which the clutch shoe is held against the mobile of the seconds, by the action of the clutch spring, in order to be driven by the mobile of the seconds by friction.

28. Watch movement of claim 27, wherein the clutch shoe is in the form of a cup comprising a lower surface intended to come into contact with the mobile of the seconds in the engaged configuration of the chronograph mobile and the clutch spring in contact with a shoulder or collar of the chronograph axis in order to press the cup against the mobile of the seconds.

29. Watch movement of claim 28, wherein an upper part of the cup comprises an annular edge, the respective distal parts of the main lever and of the secondary lever coming to be located below the annular edge in order to displace the clutch shoe axially so that the latter is disengaged from the mobile of the seconds when the chronograph mobile is brought into the disengaged configuration.

30. Timepiece comprising the watch movement of claim 24.
